(19) United States
(12) Patent Application Publication
(10) Pub. No.: US 2016/0142885 A1
(43) Pub. Date: May 19, 2016

(54) VOICE CALL PROMPTING METHOD AND DEVICE

(71) Applicant: Xiaomi Inc., Beijing (CN)

(72) Inventors: Feiyun LI, Beijing (CN); Yue Liang, Beijing (CN); Enxing Hou, Beijing (CN)

(73) Assignee: Xiaomi Inc.

(21) Appl. No.: 14/871,001

(22) Filed: Sep. 30, 2015

Related U.S. Application Data
(63) Continuation of application No. PCT/CN2015/080809, filed on Jun. 4, 2015.

(30) Foreign Application Priority Data
Nov. 18, 2014 (CN) 201410659725.1

(51) Int. Cl. H04W 4/06; H04N 5/232; H04N 7/18; H04M 1/60

(52) U.S. Cl. CPC H04W 4/06; H04M 1/6033; H04N 5/23206; H04N 7/188

(57) ABSTRACT

A voice call prompting method, includes: acquiring a current time at which voice information from a terminal device is received; determining a time interval between the current time and a last time of broadcasting voice information; and if the time interval is longer than a predetermined time period, generating a prompt of broadcasting the received voice information.

### CROSS-REFERENCE TO RELATED APPLICATIONS

This application is a continuation of International Application No. PCT/CN2015/080809, filed Jun. 4, 2015, which is based upon and claims priority to Chinese Patent Application No. 201410659725.1, filed Nov. 18, 2014, the entire contents of all of which are incorporated herein by reference.

### TECHNICAL FIELD

The present disclosure generally relates to the field of communication technology and, more particularly, to a voice call prompting method and device.

### BACKGROUND

Smart cameras play an important role in monitoring home security. For example, images captured by a smart camera can be transmitted to a remote terminal device via a network. In addition, a user located at the side of the smart camera can use the smart camera to have voice conversations with a user at the side of the terminal device. Conventionally, the smart camera directly broadcasts voice information received from the terminal device. However, the user at the side of the smart camera may be unprepared and therefore frightened by unexpected broadcasting of the voice information.

### SUMMARY

According to a first aspect of the present disclosure, there is provided a voice call prompting method, comprising: acquiring a current time at which voice information from a terminal device is received; determining a time interval between the current time and a last time of broadcasting voice information; and if the time interval is longer than a predetermined time period, generating a prompt of broadcasting the received voice information.

According to a second aspect of the present disclosure, there is provided a voice call prompting device, comprising: a processor; and a memory for storing instructions executable by the processor; wherein the processor is configured to: acquire a current time at which voice information from a terminal device is received; determine a time interval between the current time and a last time of broadcasting voice information; and if the time interval is longer than a predetermined time period, generate a prompt of broadcasting the received voice information.

According to a third aspect of the present disclosure, there is provided a non-transitory computer-readable storage medium storing instructions that, when executed by one or more processors of a device, cause the device to perform a voice call prompting method, the method comprising: acquiring a current time at which voice information from a terminal device is received; determining a time interval between the current time and a last time of broadcasting voice information; and if the time interval is longer than a predetermined time period, generating a prompt of broadcasting the received voice information.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flowchart of a voice call prompting method, according to an exemplary embodiment.

FIG. 2 is a flowchart of a voice call prompting method, according to an exemplary embodiment.

FIG. 3 is a flowchart of a voice call prompting method, according to an exemplary embodiment.

FIG. 4 is a flowchart of a voice call prompting method, according to an exemplary embodiment.

FIG. 5 is a block diagram of a voice call prompting device, according to an exemplary embodiment.

FIG. 6 is a block diagram of a voice call prompting device, according to an exemplary embodiment.

FIG. 7 is a block diagram of a voice call prompting device, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

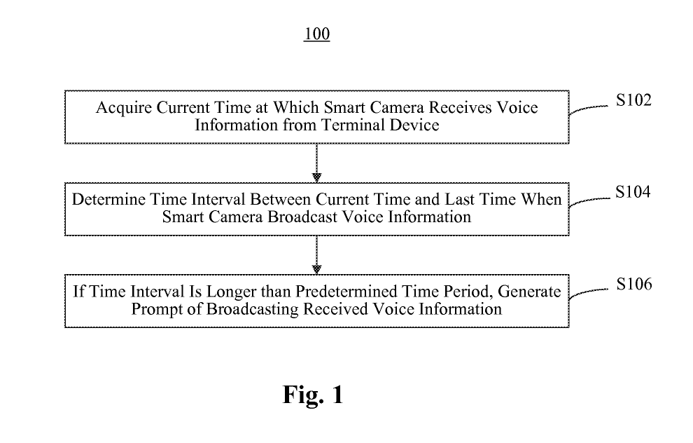

FIG. 1 is a flowchart of a voice call prompting method 100, according to an exemplary embodiment. For example, the method 100 may be used in a smart camera, such as a smart video camera, a smart camera head, etc. Referring to FIG. 1, the method 100 includes the following steps.

In step S102, the smart camera acquires a current time at which the smart camera receives voice information from a terminal device.

In exemplary embodiments, the smart camera may include a communication module capable of accessing the Internet. The smart camera may use the communication module to establish a communication connection with the terminal device via the Internet, and to receive voice information from the terminal device. For example, when receiving voice information from the terminal device, the smart camera may determine that the current time at which the smart camera receives the voice information is 10:05 a.m., Nov. 12, 2014.

In step S104, the smart camera determines a time interval between the current time and a last time when the smart camera broadcast voice information.

For example, the last time when the smart camera broadcast voice information is 10:00 a.m., Nov. 12, 2014. The smart camera counts the time elapsed from 10:00 a.m. If the smart camera receives the current voice information at 10:05 a.m., the time interval between the current time and the last time of broadcasting is 5 minutes.

In step S106, if the time interval is longer than a predetermined time period, the smart camera generates a prompt of broadcasting the received voice information.

The predetermined time period may be set according to the habit of a user. In the above described example, the user may set the predetermined time period to be 3 minutes. The time interval, i.e., 5 minutes in the example, is longer than 3 minutes, so the smart camera generates a prompt of broadcasting the received voice information. On the contrary, if the time interval is shorter than the predetermined time period, the smart camera does not generate the prompt, but broadcasts the received voice information directly.

In exemplary embodiments, step S106 may include generating the prompt by playing a prompting sound, flashing a signal light, or controlling an audio player to broadcast the received voice information in a gradually increased volume.

In some embodiments, the method 100 further includes broadcasting the received voice information after the prompt is generated.

The method 100 prompts the user located at the side of the smart camera to get prepared for the broadcasting of voice information when the time interval between two successive broadcastings is longer than a predetermined time period. This way, the method 100 prevents the user from being frightened by unexpected broadcasting of voice information. Thus, the user experience is improved.

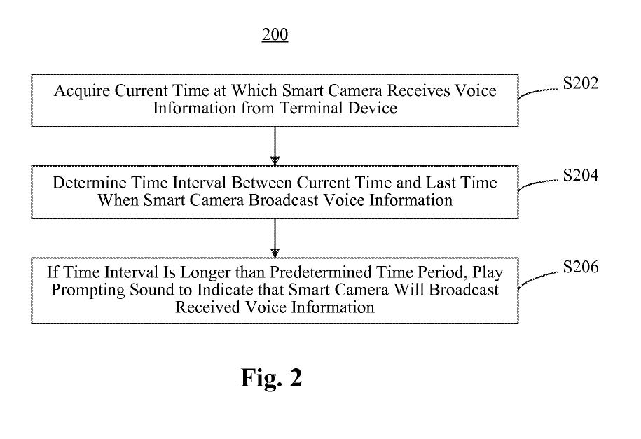

FIG. 2 is a flowchart of a voice call prompting method 200, according to an exemplary embodiment. For example, the method 200 may be used in a smart camera. Referring to FIG. 2, the method 200 includes the following steps.

In step S202, the smart camera acquires a current time at which the smart camera receives voice information from a terminal device.

In step 204, the smart camera determines a time interval between the current time and a last time when the smart camera broadcast voice information.

In exemplary embodiments, steps S202-S204 are similar to steps S102-S104 (FIG. 1), respectively.

In step S206, if the time interval is longer than a predetermined time period, the smart camera plays a prompting sound to indicate that the smart camera will broadcast the received voice information.

In exemplary embodiments, the smart camera may play a pre-stored prompting sound, such as “ding-dong”. Furthermore, the user of the smart camera may set one or more favorite prompting sounds in the smart camera. For example, the user may record the user's own voice as a prompting sound. The user may also record voice of a person at the side of the terminal device as a prompting sound, so that the smart camera can play the prompting sound of the person who also spoke the received voice information.

In exemplary embodiments, the method 200 may further include: recognizing the sound of the voice information received from the terminal device; matching the sound of the received voice information with sounds of one or more pre-recorded voices; if the sound of the received voice information matches with the sound of a pre-recorded voice, playing the matched pre-recorded voice as the prompting sound; and if the matching is unsuccessful, playing a default prompting sound. In this manner, the method 200 can play a prompting sound and voice information that are spoken by the same person, and thus further improves the user experience.

In exemplary embodiments, the method 200 further includes broadcasting the received voice information after the prompting sound is played.

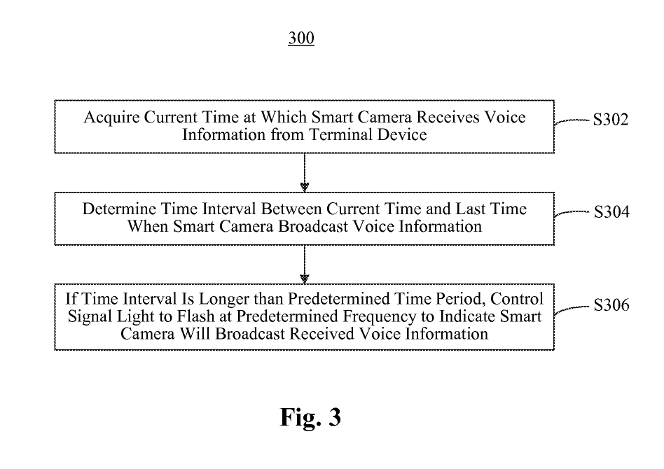

FIG. 3 is a flowchart of a voice call prompting method 300, according to an exemplary embodiment. For example, the method 300 may be used in a smart camera. Referring to FIG. 3, the method 300 includes the following steps.

In step S302, the smart camera acquires a current time at which the smart camera receives voice information from a terminal device.

In step 304, the smart terminal determines a time interval between the current time and a last time when the smart camera broadcast voice information.

In exemplary embodiments, steps S302-S304 are similar to steps S102-S104 (FIG. 1), respectively.

In step S306, if the time interval is longer than a predetermined time period, the smart camera controls a signal light to flash in a predetermined frequency to indicate that the smart camera will broadcast the received voice information.

The signal light is used for indicating an operating status of the smart camera. For example, a constant signal light may indicate that the smart camera is in a normal operating status, and a flashing signal light may indicate that the smart camera is in a process of establishing a connection with a communication network. In exemplary embodiments, the signal light may also be controlled to flash in a predetermined frequency to indicate that the smart camera will broadcast the received voice information. When seeing the signal light is flashing, the user can get prepared to listen to the received voice information without being frightened. Thus, the user experience is improved.

In exemplary embodiments, the method 300 further includes broadcasting the received voice information after the signal light flashes for a predetermined amount of time.

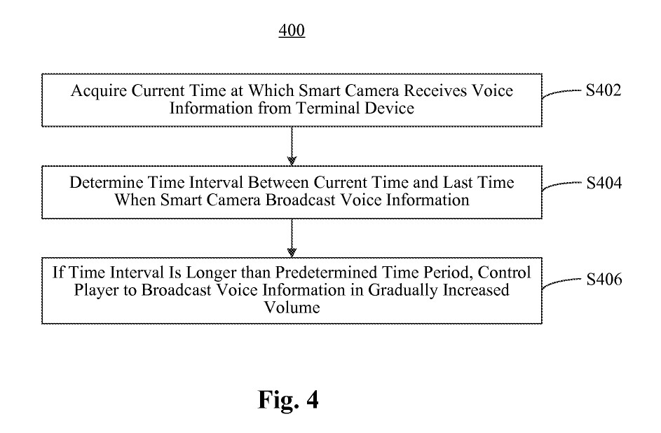

FIG. 4 is a flowchart of a voice call prompting method 400, according to an exemplary embodiment. For example, the method 400 may be used in a smart camera. Referring to FIG. 4, the method 400 includes the following steps.

In step S402, the smart camera acquires a current time at which the smart camera receives voice information from a terminal device.

In step 404, the smart camera determines a time interval between the current time and a last time when the smart camera broadcast voice information.

In exemplary embodiments, steps S402-S404 are similar to steps S102-S104 (FIG. 1), respectively.

In step S406, if the time interval is longer than a predetermined time period, the smart camera controls a player to broadcast the received voice information in a gradually increased volume.

In exemplary embodiments, the voice information may be broadcast by an audio player. The smart camera may control the audio player to gradually increase the volume from low to high, so that the user at the side of the smart camera will not be frightened by the broadcasting of the voice information.

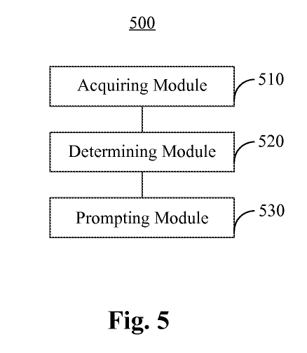

FIG. 5 is a block diagram of a voice call prompting device 500, according to an exemplary embodiment. For example, the device 500 may be a part or whole of a smart camera. Referring to FIG. 5, the device 500 includes an acquiring module 510, a determining module 520, and a prompting module 530.

The acquiring module 510 is configured to acquire a current time at which the smart camera receives voice information from a terminal device. The determining module 520 is configured to determine a time interval between the current time and a last time when the smart camera broadcast voice information. The prompting module 530 is configured to generate a prompt of broadcasting the received voice information, if the time interval is longer than a predetermined time period.

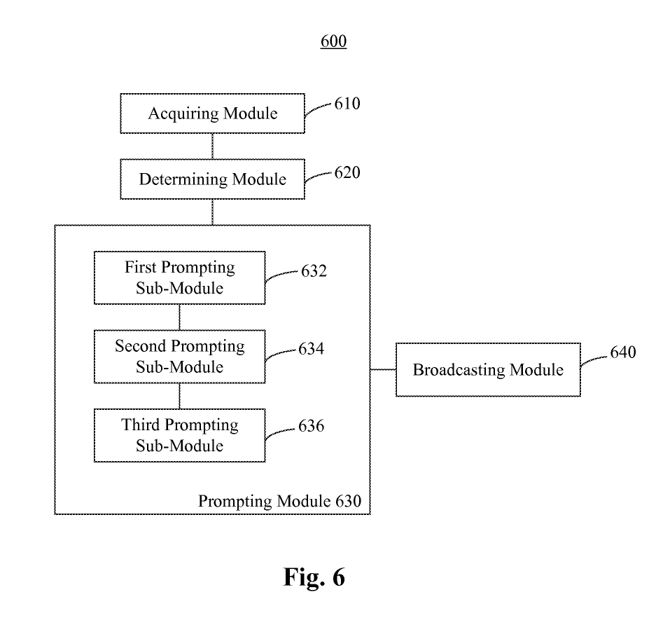

FIG. 6 is a block diagram of a voice call prompting device 600, according to an exemplary embodiment. For example, the device 600 may be a part or whole of a smart camera. Referring to FIG. 6, the device 600 includes an acquiring module 610, a determining module 620, and a prompting 630, similar to the acquiring module 510, the determining module 520, and the prompting module 530 (FIG. 5), respectively.

In some embodiments, referring to FIG. 6, the prompting module 630 further includes a first prompting sub-module 632, and/or a second prompting sub-module 634. The first prompting sub-module 632 is configured to play a prompting sound. The second prompting sub-module 634 is configured to control a signal light to flash in a predetermined frequency.

In some embodiments, the device 600 further includes a recognizing module and a matching module (not shown in FIG. 6). The recognizing module is configured to recognize a sound of the voice information received from the terminal device. The matching module is configured to match the sound of the received voice information with sounds of one or more pre-recorded voices. If the sound of the received voice information matches the sound of a pre-recorded voice, the prompting module 630 plays the matched pre-recorded voice as a prompting sound. If the matching is unsuccessful, the prompting module 630 plays a default prompting sound to indicate that the smart camera will broadcast the received voice information.

In some embodiments, referring to FIG. 6, the device 600 further includes a broadcasting module 640 configured to broadcast the voice information received from the terminal device.

In some embodiments, the prompting module 630 further includes a third prompting sub-module 636 configured to control the broadcasting module 640 or a different audio player to broadcast the received voice information in a gradually increased volume. terminal device.

Although a smart camera is used as an example in the above description, one of ordinary skill in the art will understand that the present disclosure is not so limited. For example, the above described methods can also be used in a mobile phone, a computer, a digital broadcast terminal, a messaging device, a gaming console, a tablet, a medical device, exercise equipment, a personal digital assistant, or any other device that can communicate with a terminal device.

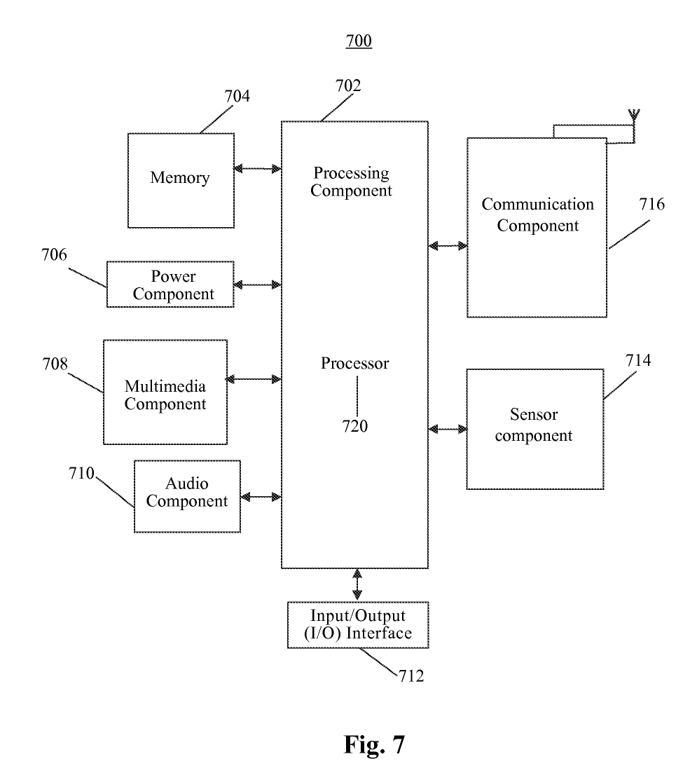

FIG. 7 is a block diagram of a voice call prompting device 700, according to an exemplary embodiment. For example, the device 700 may be a smart camera, a mobile phone, a computer, a digital broadcast terminal, a messaging device, a gaming console, a tablet, a medical device, exercise equipment, a personal digital assistant, and the like.

Referring to FIG. 7, the device 700 may include one or more of the following components: a processing component 702, a memory 704, a power component 706, a multimedia component 708, an audio component 710, an input/output (I/O) interface 712, a sensor component 714, and a communication component 716.

The processing component 702 typically controls overall operations of the device 700, such as the operations associated with display, telephone calls, data communications, camera operations, and recording operations. The processing component 702 may include one or more processors 720 to execute instructions to perform all or part of the steps in the above described methods. Moreover, the processing component 702 may include one or more modules which facilitate the interaction between the processing component 702 and other components. For instance, the processing component 702 may include a multimedia module to facilitate the interaction between the multimedia component 708 and the processing component 702.

The memory 704 is configured to store various types of data to support the operation of the device 700. Examples of such data include instructions for any applications or methods operated on the device 700, contact data, phonebook data, messages, pictures, video, etc. The memory 704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 706 provides power to various components of the device 700. The power component 706 may include a power management system, one or more power sources, and any other components associated with the generation, management, and distribution of power in the device 700.

The multimedia component 708 includes a screen providing an output interface between the device 700 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 708 includes a front camera and/or a rear camera. The front camera and/or the rear camera may receive external multimedia data while the device 700 is in an operation mode, such as a photographing mode or a video mode. Each of the front camera and the rear camera may be a fixed optical lens system or have focus and optical zoom capability.

The audio component 710 is configured to output and/or input audio signals. For example, the audio component 710 includes a microphone configured to receive an external audio signal when the device 700 is in an operation mode, such as a call mode, a recording mode, and a voice recognition mode. The received audio signal may be further stored in the memory 704 or transmitted via the communication component 716. In some embodiments, the audio component 710 further includes a speaker to output audio signals.

The I/O interface 712 provides an interface between the processing component 702 and peripheral interface modules, such as a keyboard, a click wheel, buttons, and the like. The buttons may include, but are not limited to, a home button, a volume button, a starting button, and a locking button.

The sensor component 714 includes one or more sensors to provide status assessments of various aspects of the device 700. For instance, the sensor component 714 may detect an open/closed status of the device 700, relative positioning of components, e.g., the display and the keypad, of the device 700, a change in position of the device 700 or a component of the device 700, a presence or absence of user contact with the device 700, an orientation or an acceleration/deceleration of the device 700, and a change in temperature of the device 700. The sensor component 714 may include a proximity sensor configured to detect the presence of nearby objects without any physical contact. The sensor component 714 may also include a light sensor, such as a CMOS or CCD image sensor, for use in imaging applications. In some embodiments, the sensor component 714 may also include an accelerometer sensor, a gyroscope sensor, a magnetic sensor, a pressure sensor, or a temperature sensor.

The communication component 716 is configured to facilitate communication, wired or wirelessly, between the device 700 and other devices. The device 700 can access a wireless network based on a communication standard, such as WiFi, 2G, 3G, or a combination thereof. In one exemplary embodiment, the communication component 716 receives a broadcast signal or broadcast associated information from an external broadcast management system via a broadcast channel. In one exemplary embodiment, the communication component 716 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 704, executable by the processor 720 in the device 700, for performing the above-described methods. For example, the non-transitory computer-readable storage medium may be a read-only memory (ROM), a random access memory (RAM), a CD-ROM, a magnetic tape, a floppy disc, an optical data storage device, and the like.

One of ordinary skill in the art will understand that the above-described modules can each be implemented by hardware, or software, or a combination of hardware and software. One of ordinary skill in the art will also understand that multiple ones of the above-described modules may be combined as one module, and each of the above-described modules may be further divided into a plurality of sub-modules.

Other embodiments of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact constructions that are described above and illustrated in the accompanying drawings, and that various modifications and changes can be made without departing from the scope thereof. It is intended that the scope of the invention should only be limited by the appended claims.

What is claimed is:

1. A voice call prompting method, comprising:
acquiring a current time at which voice information from a terminal device is received;
determining a time interval between the current time and a last time of broadcasting voice information; and
if the time interval is longer than a predetermined time period, generating a prompt of broadcasting the received voice information.

2. The method according to claim 1, wherein the generating of the prompt of broadcasting the received voice information comprises playing a prompting sound to indicate that the received voice information is to be broadcast.

3. The method according to claim 1, wherein the generating of the prompt of broadcasting the received voice information comprises:
recognizing a sound of the received voice information;
matching the sound of the received voice information with sounds of one or more pre-recorded voices;
if the sound of the received voice information matches the sound of a pre-recorded voice, playing the matched pre-recorded voice to indicate that the received voice information is to be broadcast; and
if the matching fails, playing a default prompting sound to indicate that the received voice information is to be broadcast.

4. The method according to claim 1, wherein the generating of the prompt of broadcasting the received voice information comprises controlling a signal light to flash at a predetermined frequency to indicate that the received voice information is to be broadcast.

5. The method according to claim 1, further comprising broadcasting the received voice information.

6. The method according to claim 1, wherein the generating of the prompt of broadcasting the voice information comprises controlling a player to broadcast the voice information in a gradually increased volume.

7. A voice call prompting device, comprising:
a processor; and
a memory for storing instructions executable by the processor;
wherein the processor is configured to:
acquire a current time at which voice information from a terminal device is received;
determine a time interval between the current time and a last time of broadcasting voice information; and
if the time interval is longer than a predetermined time period, generate a prompt of broadcasting the received voice information.

8. The device according to claim 7, wherein the processor is further configured to play a prompting sound to indicate that the received voice information is to be broadcast.

9. The device according to claim 7, wherein the processor is further configured to:
recognize a sound of the received voice information;
match the sound of the received voice information with sounds of one or more pre-recorded voices;
if the sound of the received voice information matches the sound of a pre-recorded voice, broadcast the matched pre-recorded voice to indicate that the received voice information is to be broadcast; and
if the matching fails, broadcast a default prompting sound to indicate that the received voice information is to be broadcast.

10. The device according to claim 7, wherein the processor is further configured to control a signal light to flash at a predetermined frequency to indicate that the received voice information is to be broadcast.

11. The device according to claim 7, wherein the processor is further configured to broadcast the received voice information.

12. The device according to claim 7, wherein the processor is further configured to control a player to broadcast the received voice information in a gradually increased volume.

13. A non-transitory computer-readable storage medium storing instructions that, when executed by one or more processors of a device, cause the device to perform a voice call prompting method, the method comprising:
acquiring a current time at which voice information from a terminal device is received;
determining a time interval between the current time and a last time of broadcasting voice information; and
if the time interval is longer than a predetermined time period, generating a prompt of broadcasting the received voice information.

14. The storage medium according to claim 13, wherein the generating of the prompt of broadcasting the received voice information comprises playing a prompting sound to indicate that the received voice information is to be broadcast.

15. The storage medium according to claim 13, wherein the generating of the prompt of broadcasting the received voice information comprises:
recognizing a sound of the received voice information;
matching the sound of the received voice information with sounds of one or more pre-recorded voices;
if the sound of the received voice information matches the sound of a pre-recorded voice, playing the matched pre-recorded voice to indicate that the received voice information is to be broadcast; and
if the matching fails, playing a default prompting sound to indicate that the received voice information is to be broadcast.

16. The storage medium according to claim 13, wherein the generating of the prompt of broadcasting the received voice information comprises controlling a signal light to flash at a predetermined frequency to indicate that the received voice information is to be broadcast.

17. The storage medium according to claim 13, wherein the method further comprises broadcasting the received voice information.

18. The storage medium according to claim 13, wherein the generating of the prompt of broadcasting the voice information comprises controlling a player to broadcast the voice information in a gradually increased volume.
